(19) United States
(12) Patent Application Publication
(10) Pub. No.: US 2008/0243516 A1
(43) Pub. Date: Oct. 2, 2008

(54) Daily reminder key station

(76) Inventor: Jeffrey M. Majocha, New Kensington, PA (US)

Correspondence Address: Raymond M. Galasso;Galasso & Associates LP, P.O. Box 26503, Austin, TX, 78755-0503, US

(21) Appl. No.: 11/728,813

(22) Filed: Mar. 26, 2007

(51) Int. Cl. G10L 21/00

(52) U.S. Cl. 704/272; 704/E19.001

(57) ABSTRACT

A daily reminder key station is provided and equipped with a voice memo recording and playback device integrated therein. The daily reminder key station is configured to provide an audible playback of personalized reminders for the day whenever keys or a key ring is removed from a key hook on the key station, thereby providing daily reminders of tasks and errands the individual may need to remember and to address during the day.

### FIELD OF THE DISCLOSURE

The disclosures made herein relate generally to a “to do” list, day planners, voice memo devices and, more particularly, to a daily reminder key station having a voice memo recording and playback device integrated therein and adapted to provide an audible playback of personalized reminders for the day whenever keys or a key ring is removed from a key hook on the key station.

### BACKGROUND

When an individual is about to leave home to travel to the office or to work, there are typically a multitude of tasks and errands the individual may need to remember and to address during the day. Often mental notes or paper notes are made the day before, but on the start of a new day at least a portion of the tasks one made a note to do have typically been forgotten. As a parent's life is so busy and demands are so great, there is always more to do than one has the time and opportunity to accomplish. Still, in any list of tasks to be accomplished there are always those that are priority and must be recalled and accomplished today.

When an individual returns home from work, there typically are intended actions which require future activity on the mind of the individual. In the past, recording such items for future reference was often performed using a memo pad or notepaper.

Today, portable recording devices have become available for recording short messages, such as reminder memos, to one's self and can be transported about by the user.

In spite of the above, there remains today a need in the art for a daily reminder key station equipped with a voice memo playback device activated by the removal of keys from the key hook and operable to remind the user of important tasks to be addressed during the day.

### SUMMARY OF THE DISCLOSURE

Accordingly, embodiments of the inventive disclosures made herein comprise various embodiments of a daily reminder key station for reminding a user of tasks to be addressed during the day.

In one or more embodiments of the inventive disclosures made herein, the daily reminder key station includes a decorative wall mountable housing having a shelf attached to an upper portion of the housing. The housing is in the form of a decorative key hanger device and a shelf. At least one key hook is pivotally secured to the housing. Each key hook is sized and adapted to supportively, hangably and removeably receive a key ring having keys thereon. A voice memo recording device is received within the housing and operable such that removing the key ring from the key hook causes the voice memo recorder to audibly play messages previously stored to the voice recorder. A loud speaker for reproducing played messages is secured within the housing and electrically interfaced to the voice memo recording device, or may alternately be contained within the voice memo recording device.

In one or more embodiments of the inventive disclosures made herein, the daily reminder key station is configured such that replacing the keys on the key hook terminates playback of recorded messages and resets the voice memo recorder to the beginning of the first recorded message for later playback when the keys are again removed from the key hook.

In one or more embodiments of the inventive disclosures made herein, the daily reminder key station voice memo recording device includes a microphone and wherein the housing is removed from the wall to access the recording device to record new voice memos.

In one or more embodiments of the inventive disclosures made herein, the daily reminder key station voice memo recording device includes a microphone and the key station housing includes a record control secured to a side of the housing and interfaced to the voice memo recording device, wherein depressing the record control causes the recording device to record new voice memos for later playback.

In one or more embodiments of the inventive disclosures made herein, the daily reminder key station includes an erase control secured to a side of the housing and interfaced to the voice memo recording device, wherein depressing the erase control causes the recording device to erase voice memos stored to the recording device.

In one or more embodiments of the inventive disclosures made herein, the daily reminder key station voice memo recording device is a tape recording device configured such that replacing the key ring onto the key hook causes tape to automatically rewind.

In one or more embodiments of the inventive disclosures made herein, the daily reminder key station voice memo recording device is a microprocessor based digital voice memo recorder wherein voice memos are recorded to memory in the voice memo recorder.

In one or more embodiments of the inventive disclosures made herein, the daily reminder key station housing includes an erase control secured to a side of the housing and interfaced to the voice memo recording device. The erase control is configured such that depressing the erase control permits individual voice memos to be selectively erased while leaving other voice memos present for later playback. To selectively erase a particular memo the erase key is depressed while the memo message is being played.

In one or more embodiments of the inventive disclosures made herein, the daily reminder key station housing is made of materials including plastic, wood and metal.

In one or more embodiments of the inventive disclosures made herein, the daily reminder key station housing has dimensions of four inches high, six to eight inches long and three inches wide with an overall rectangular shape.

It is an objective of the inventive disclosure made herein to provide a daily reminder key station equipped with a voice memo playback device activated by the removal of keys from the key hook and operable to remind the user of important tasks to be addressed during the day.

These and other objects of the invention made herein will become readily apparent upon further review of the following specification and associated drawings.

### BRIEF DESCRIPTION OF THE DRAWINGS

The drawings show a form of the invention that is presently preferred; however, the invention is not limited to the precise arrangement shown in the drawings.

FIG. 1 presents a front perspective view of one embodiment of the daily reminder key station in accordance with the inventive disclosures herein.

FIG. 2 presents a sectional view along 2-2 of FIG. 1 of one embodiment of the daily reminder key station in accordance with the inventive disclosures herein.

### DETAILED DESCRIPTION OF THE DRAWINGS

In preparation for explaining the details of the present inventive disclosure, it is to be understood by the reader that the invention is not limited to the presented details of the construction, materials and embodiments as illustrated in the accompanying drawings, as the invention concepts are clearly capable of other embodiments and of being practiced and realized in various ways by applying the disclosure presented herein.

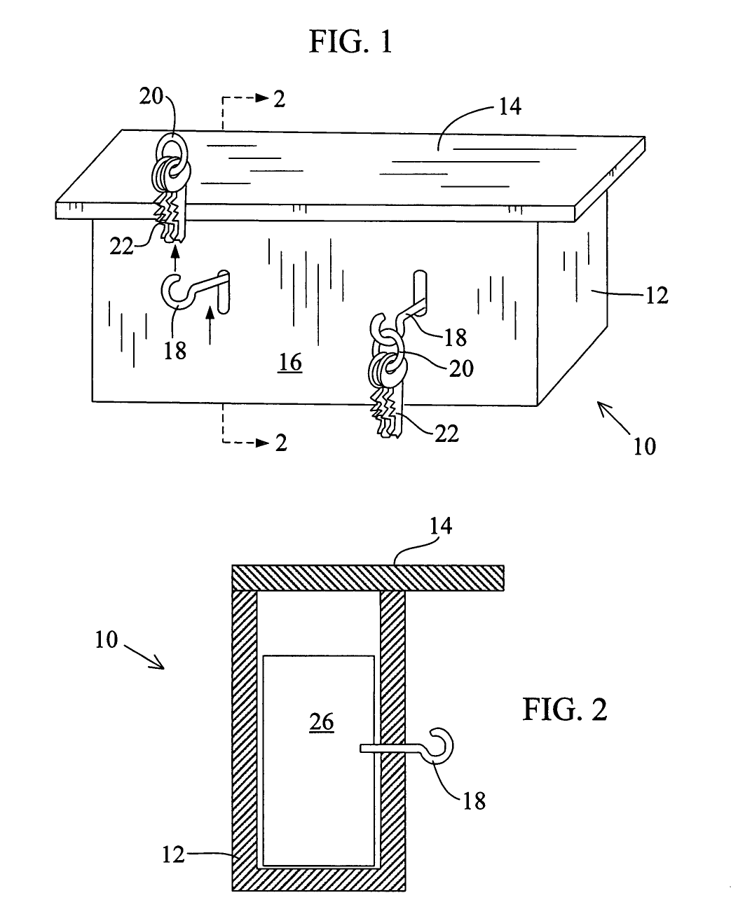

Turning now to FIG. 1 and FIG. 2:

FIG. 1 presents a front perspective view of one embodiment of the daily reminder key station in accordance with the inventive disclosures herein. FIG. 2 presents a sectional view along 2-2 of FIG. 1 of one embodiment of the daily reminder key station in accordance with the inventive disclosures herein. A daily reminder key station 10 includes a wall mountable housing 12 having a shelf 14 attached to an upper portion of the housing 12 with the housing 12 forming a decorative key hanger and shelf.

Two key hooks 18 are provided and are pivotally secured to the front 16 of the housing 12. Each key hook 18 is sized and adapted to supportively, hangably and removeably receive a key ring 20 having keys 22 thereon. Within the housing 12 is a voice memo recording device received within the housing, wherein removing the key ring from the key hook causes the voice memo recorder 26 to audibly play messages stored to the voice recorder 26.

The daily reminder key station 10 is configured such that replacing the keys 22 on the key hook 18 terminates playback of recorded messages and resets the voice memo recorder 26 to the beginning of the first recorded message for later playback when the keys are removed from the key hook 18.

The daily reminder key station 10 acts as a personal checklist for people to make sure that they have not forgotten any important events or tasks for the day. The system is easy to use and potentially saves time and worry for any user by providing friendly, personalized reminders. In addition to the memo and task list recoding capabilities, the daily reminder key station 10 serves as a storage place for all keys in the house. Many people return home and drop keys on whatever surface they see first. When it comes time to find them, they need to check the entire house, since they are accustomed to just dropping their keys in multiple locations.

People's lifestyles are so busy and hectic, and their minds are so full of assorted information, it is completely common to forget important tasks to do. Some people try to leave little notes around the house while others make long to-do lists. Still, people can forget a doctor's appoinment, meeting or other similar engagement. The daily reminder key station 10 fulfills a need by providing an audible prompting reminder of important events and tasks for the day.

The discussed construction, illustrations and sequence of operation is for one embodiment of the invention, but is in no way limiting to other embodiments. The operating modes may be changed and enhanced without deviating from the intention of this inventive disclosure.

In the preceding detailed description, reference has been made to the accompanying drawings that form a part hereof, and in which are shown by way of illustration specific embodiments in which the invention may be practiced. These embodiments and certain variants thereof have been described in sufficient detail to enable those skilled in the art to practice the invention. It is to be understood that other suitable embodiments may be utilized and that logical, material, and mechanical changes may be made without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A daily reminder key station comprising:
a wall mountable housing having a shelf attached to an upper portion of the housing, the housing forming a decorative key hanger and shelf;
at least one key hook pivotally secured to said housing, each key hook sized and adapted to supportively, hangably and removeably receive a key ring having keys thereon;
a voice memo recording device received within said housing, wherein removing said key ring from said key hook causes said voice memo recorder to audibly play messages stored to said voice recorder; and
a loud speaker for reproducing played messages, said loud speaker secured within said housing and electrically interfaced to said voice memo recording device.

2. The daily reminder key station according to claim 1, wherein replacing said keys on said key hook terminates playback of recorded message and resets said voice memo recorder to the beginning of the first recorded message for later playback when said keys are removed.

3. The daily reminder key station according to claim 2, wherein said voice memo recording device includes a microphone and wherein said housing is removed from said wall to access said recording device to record new voice memos.

4. The daily reminder key station according to claim 2, wherein said voice memo recording device includes a microphone and wherein said housing includes a record control secured to a side of said housing and interfaced to said voice memo recording device, wherein depressing said record control causes said recording device to record new voice memos for later playback.

5. The daily reminder key station according to claim 4, wherein said housing includes an erase control secured to a side of said housing and interfaced to said voice memo recording device, wherein depressing said erase control causes said recording device to erase voice memos stored to said recording device.

6. The daily reminder key station according to claim 4, wherein
said voice memo recording device is a tape recording device; and
wherein replacing said key onto said key hook causes tape to automatically rewind.

7. The daily reminder key station according to claim 4, wherein said voice memo recording device is a microprocessor based digital voice memo recorder; wherein voice memos are recorded to memory in said voice memo recorder.

8. The daily reminder key station according to claim 7, wherein said housing includes an erase control secured to a side of said housing and interfaced to said voice memo recording device, wherein depressing said erase control during memo playback permits individual voice memos to be selectively erased while leaving other voice memos present for later playback.

9. The daily reminder key station according to claim 4, wherein said housing comprises any material selected from the set including plastic, wood and metal.

10. The daily reminder key station according to claim 8, wherein said housing has dimensions of four inches high, six to eight inches long and three inches wide with an overall rectangular shape.
